(19) United States
(12) Patent Application Publication
(10) Pub. No.: US 2008/0071673 A1
(43) Pub. Date: Mar. 20, 2008

(54) Financial-aid information aggregator

(76) Inventors: Kenneth R. Howard, Allen, TX (US); William W. Huckabee, Sachse, TX (US); Stephen H. Wright, Dallas, TX (US); Hiep Nguyen, Carrollton, TX (US); Sara D. Mattice, Farmersville, TX (US); Jennifer L. Reeves, Frixco, TX (US); James G. Johnson, Fort Worth, TX (US); Albert S. Baines, Little Elm, TX (US)

Correspondence Address: INTUIT, INC.;c/o PARK, VAUGHAN & FLEMING LLP, 2820 FIFTH STREET, DAVIS, CA, 95618-7759, US

(21) Appl. No.: 11/508,026

(22) Filed: Aug. 21, 2006

(51) Int. Cl. G06Q 40/00

(52) U.S. Cl. 705/38; 705/35

(57) ABSTRACT

In order to generate a financial-aid application, a system provides an electronic template that is compatible with a format of the financial-aid application, and the system retrieves stored financial information for a first individual. This financial information includes one or more income tax returns that are stored in a format that is compatible with financial planning software. Furthermore, the system merges the financial information with the electronic template to complete at least a portion of the financial-aid application.

### BACKGROUND

The present invention relates to techniques for aggregating information.

The cost of secondary education has increased significantly in recent years. As a consequence, many students apply for assistance in the form of financial aid and grants. To streamline this process, applicants are required to complete one or more annual applications to assess their financial need. For example, an assessment of a student's financial need and, thus, eligibility for federal programs is determined based on the information provided by the student each year in a Free Application for Federal Student Aid (FAFSA). Similar applications are used to allocate state or local financial aid, as well as funds under programs such as the GI Bill.

Unfortunately, these applications request a wide variety of financial information. This information is often maintained by several institutions, such as banks and financial service providers. Therefore, when completing one of these financial-aid applications, a given student may need to assemble data from multiple sources at different locations. This is typically a time-consuming and complicated process. Furthermore, it is often difficult for students to determine the financial consequences of the information they are providing in these applications. As a consequence, it is difficult for students to plan accordingly.

At the same time, financial planning software is becoming increasingly popular. This software offers a broad range of functionality to users, such as the ability to analyze the financial consequences of retirement plans and the ability to prepare annual income tax return forms. In the process, these programs often assemble considerable financial information about their users. However, existing financial planning software is not configured to leverage this information to assist students in completing financial-aid applications or in assessing the financial consequences of this information for student eligibility.

### SUMMARY

One embodiment of the present invention provides a system that generates a financial-aid application. The system provides an electronic template that is compatible with a format of the financial-aid application, and also retrieves stored financial information for a first individual. This financial information includes one or more income tax returns that are stored in a format that is compatible with financial planning software. Furthermore, the system merges financial information with the electronic template to complete at least a portion of the financial-aid application.

In some embodiments, the financial information further includes bank statements and/or investment records. In addition, in some embodiments the financial planning software includes Quicken™ or TurboTax™.

In some embodiments, the financial-aid application includes a Free Application for Federal Student Aid (FAFSA). And in some embodiments, the financial information is stored at a remote location and is accessed via a network.

In some embodiments, the system receives additional information corresponding to the first individual and merges the additional information with the electronic template. This additional information may include an address, a phone number, a Social Security number, and/or a driver's license number.

In some embodiments, the system verifies accuracy of information that is merged with the electronic template and/or determines that additional information is required to complete the financial-aid application. If additional information is required, the system may provide a list of the additional information, the system may query a user for at least a portion of the additional information, and/or the system may send a request to a third party for at least a portion of the addition information.

In some embodiments, the system additionally stores and/or retrieves a partially completed electronic template.

In some embodiments, the system receives a security token corresponding to the first individual.

In some embodiments, the system determines if the first individual is a financial dependent of a second individual. If the first individual is a financial dependent of the second individual, the system may retrieve stored financial information for the second individual and may merge this information with the electronic template to complete at least another portion of the financial-aid application.

In some embodiments, the system predicts eligibility of the first individual for financial-aid based on a targeted educational institution, an annual expense associated with the targeted educational institution, and/or the financial information.

In some embodiments, the system electronically submits the electronic template to an organization that determines eligibility of the first individual for financial aid.

Another embodiment provides a computer system that is configured to execute instructions for the above-described operations.

Another embodiment provides a computer program product for use in conjunction with the computer system.

### BRIEF DESCRIPTION OF THE FIGURES

FIG. 1 is a block diagram illustrating a number of computer system that are networked together in accordance with an embodiment of the present invention.

FIG. 2 is a block diagram illustrating a computer system in accordance with an embodiment of the present invention.

FIG. 3 is a flow chart illustrating a process for generating a financial-aid application in accordance with an embodiment of the present invention.

FIG. 4 is a flow chart illustrating a process for generating a financial-aid application in accordance with an embodiment of the present invention.

FIG. 5 is a block diagram illustrating a data structure in accordance with an embodiment of the present invention.

FIG. 6 is a block diagram illustrating a data structure in accordance with an embodiment of the present invention.

Note that like reference numerals refer to corresponding parts throughout the drawings.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

Embodiments of a computer system, a method, and a computer program product (i.e., software) for use with the computer system are described. These devices and processes may be used to generate a financial-aid application, such as a Free Application for Federal Student Aid (FAFSA). In particular, stored financial information for a student is retrieved and merged with an electronic template, which is compatible with a format of the financial-aid application. In this way, at least a portion of the financial-aid application is completed, and is either stored for later use or is submitted (for example, electronically) to an organization that determines eligibility of the student for financial aid.

The financial information may include one or more annual income tax returns (which may be stored in a format that is compatible with financial planning software, such as Quicken™, TurboTax™, or other software capable of receiving financial related data, bank statements, and/or investment records. Note that by using the information available to such financial planning programs, the process of assembling and completing the financial-aid application may be simplified.

The accuracy of the information that is received and/or merged with the electronic template may be verified. If needed, additional information required to complete the financial-aid application may be requested. Furthermore, whether or not the student is financially dependent on another individual(s), such as a parent or a guardian, may be determined. If the student is a dependent, financial information for this other individual(s) may be retrieved and merged with the electronic template. And in some embodiments, the eligibility of the student for financial aid is predicted based, among other factors, on a university or college the student intends to apply to. Such predictions may allow the student to plan for the financial consequences of the information they are providing in the financial-aid application.

This approach may be implemented as a stand-alone software application, or as a program module or subroutine in another application, such as the financial planning software. Furthermore, the software may be configured to execute on a client computer, such as a personal computer, a laptop computer, cell phone, PDA, or other device capable of manipulating computer readable data, or between two or more computing systems over a network (such as the Internet, World Wide Web or WWW, Intranet, LAN, WAN, MAN, or combination of networks, or other technology enabling communication between computing systems). Therefore, the financial information may be stored locally (for example, on a local computer) and/or remotely (for example, on a computer or server that is accessed via a network).

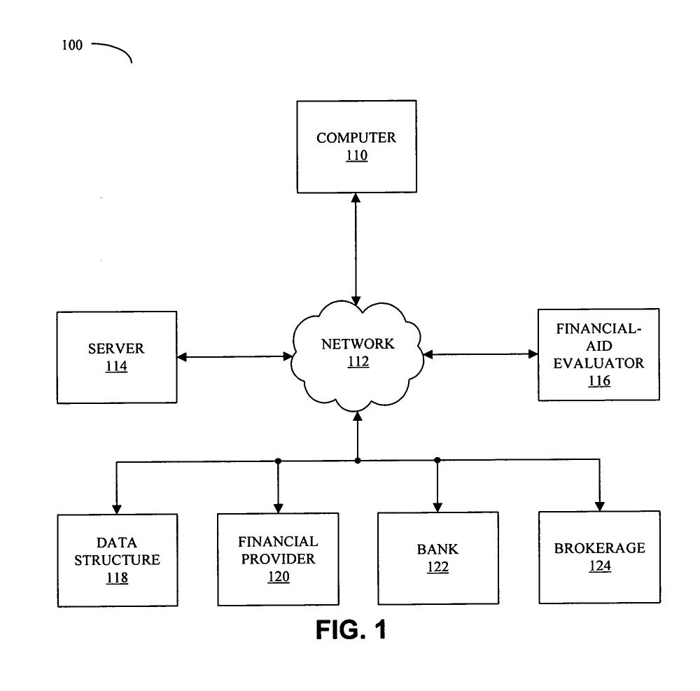

We now describe embodiments of a computer system, a method, and software for generating a financial-aid application. FIG. 1 provides a block diagram illustrating a computer system 100 that includes a number of computers and servers that are networked together in accordance with an embodiment of the present invention. One or more users may complete at least a portion of a financial-aid application (such as FAFSA) using a financial-aid program that executes on computer 110. As noted above, this financial-aid program may be a stand-alone application or may be embedded in another application. In one embodiment, the financial-aid program is embedded in financial planning software, such as Quicken™ and/or TurboTax™ (from Intuit, Inc., of Mountain View, Calif.), Microsoft Money™ (from Microsoft Corporation, of Redmont, Wash.), SplashMoney™ (from SplashData, Inc., Los Gatos, Calif.), Mvelopes™ (from In2M, Inc., Draper, Utah), and/or open-source applications such as Gnucash™, PLCash™, and/or Budget™ (from Snowmint Creative Solutions, LLC).

The financial-aid program may be resident on the computer 100. However, other embodiments may utilize a financial-aid tool that is embedded in a web page (once again, either as a stand-alone application or as a portion of another application). This web page may be provided by server 114 via network 112. In an exemplary embodiment, the financial-aid tool is a software package written in JavaScript™ (i.e., the fiancial-aid tool includes programs or procedures containing JavaScript instructions), ECMAScript (the specification for which is published by the European Computer Manufacturers Association International), VBScript™ (a trademark of Microsoft, Inc.) or any other client-side scripting language. In other words, the embedded financial-aid tool may include programs or procedures containing JavaScript, ECMAScript instructions, VBScript instructions, or instructions in another programming language suitable for rendering by a browser or another client application on the computer 110.

The financial-aid program may provide the user with an electronic template that is compatible with a format of the financial-aid application. The financial-aid program may access and retrieve stored financial information for a given student. This financial information may be stored locally on the computer 110 or remotely, for example, on the server 114, in a data structure 118, or in the financial records or a financial provider 120, a bank 120, and/or a brokerage 122. For example, the financial information may include bank records stored at the bank 120 (or in the financial records that are maintained by the bank 120), or the financial information may include investment records stored at the brokerage 120 (or in the financial records that are maintained by the brokerage 122).

In an exemplary embodiment, the financial information includes one or more income tax returns that are stored in a format that is compatible with the financial planning software. Note that the financial information may therefore include data from current and/or previous years. In addition, the financial-aid program may access financial-aid applications from one or more previous years.

While using the financial-aid program, a user, such as the given student, may provide additional information that is needed to complete the financial-aid application. For example, the user may provide demographic information, an address, a phone number, a Social Security number, and/or a driver's license number.

Once the financial information and/or the additional information have been provided, they may be merged with the electronic template to complete at least a portion of the financial-aid application. Furthermore, either prior to or after this merge operation, the financial-aid program may verify the accuracy of the information that is received.

The financial-aid program may also determine that additional information is needed to complete the financial-aid application. If additional information is needed, the user may be notified. For example, a list of the additional information may be provided (it may be displayed or printed out). Alternatively, the user may be queried for at least some of the remaining information that is needed. However, in some embodiments the financial-aid program sends a request to one of more third parties (such as the bank 122) for such information.

One typical complication associated with financial-aid applications is that financial information for individuals other than the given student may sometimes be required. For example, if the student is considered to be a dependent (for example, the student lives with his or her parents or is younger than a certain age) financial information for the student's parent(s) or guardian(s) may be needed. To accommodate this circumstance, the financial-aid program may determine if the student is financial dependent on another individual(s). If the student is considered a dependent, financial information and/or addition information for the other individual(s) (for example, a number of other children attending college) may be accessed and retrieved, and/or requested. This financial and/or additional information may also be merged with the electronic template.

In addition, to allow the given student and/or another individual to determine and/or plan for the consequences of the information that is being provided in the financial-aid application, the financial-aid program may predict the eligibility of the given student for financial-aid. In an exemplary embodiment, the prediction is based on one or more targeted educational institution(s) (for example, Tufts University), an annual expense associated with the targeted educational institution(s), and the financial information for the student and/or his or her parent(s) or guardian(s). Note that the financial-aid program may access a database and/or a data structure, such as the data structure 118, to obtain information about schools and their associated costs while performing the prediction analysis. The predictions may include a financial amount that the student can be expected to pay should he or she attend a given school. Based on this estimate, the student may choose to apply for other types of financial aid offered by another organization or to apply to a different educational institution.

The user of the financial-aid program may complete the electronic template, and thus the financial-aid application, on one or more occasions. Thus, in some embodiments the user may skip certain questions and/or portions of the electronic template and store a partially complete electronic template for future use. In addition, in some embodiments when the financial-aid program is started a stored partially completed electronic template is accessed and retrieved. Note that such a partially complete electronic template may be stored locally and/or remotely from the computer 110.

Once the electronic-template is completed, the user of the financial-aid program may submit the electronic template, or the financial-aid application that it is compatible with, to a financial-aid evaluator 116. The financial-aid evaluator 116 determines the eligibility of student for financial aid. In an exemplary embodiment, the electronic template is submitted electronically via the network 112. However, in other embodiments the electronic template may be converted into the format of the financial-aid application, printed out, and submitted by conventional techniques, such as mail and/or facsimile.

The material included in the electronic template is of a sensitive nature. As a consequence, in some embodiments the student and/or his or her patent(s) or guardian(s) may provide one or more security tokens, such as a PIN code, a user name, and/or a password) in order to use the financial-aid program or to access associated stored files or stored financial information. In addition, in some embodiments the stored files, the stored financial information, and/or data communicated over the network 112 are encrypted. Note that in some embodiments the computer system 100 includes fewer or additional components, two or more components are combined into a single component, and/or a position of one or more components may be changed.

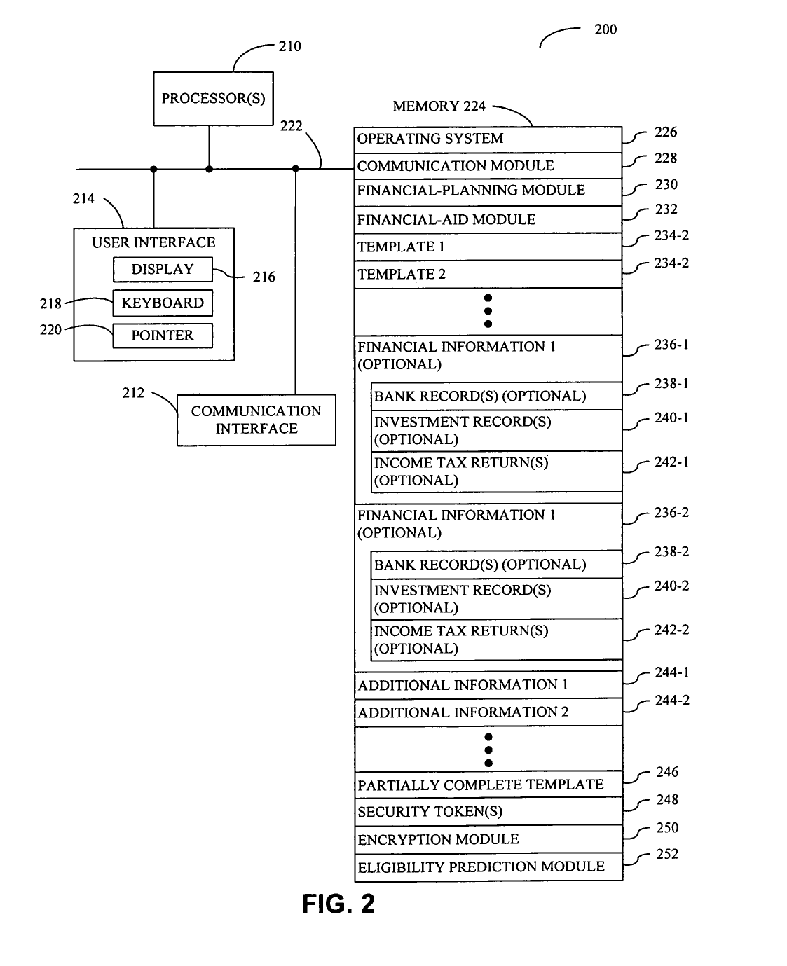

FIG. 2 provides a block diagram illustrating a computer system 200 in accordance with an embodiment of the present invention. The computer system 200 includes one or more processors 210, a communication interface 212, a user interface 214, and one or more signal lines 222 coupling these components together. Note that the one or more processing units 210 may support parallel processing and/or multi-threaded operation, the communication interface 212 may have a persistent communication connection, and the one or more signal lines 222 may constitute a communication bus. Moreover, the user interface 214 may include a display 216, a keyboard 218, and/or a pointer 220, such as a mouse.

Memory 224 in the computer system 200 may include volatile memory and/or non-volatile memory. More specifically, memory 224 may include ROM, RAM, EPROM, EEPROM, FLASH, one or more smart cards, one or more magnetic disc storage devices, and/or one or more optical storage devices. Memory 224 may store an operating system 226 that includes procedures (or a set of instructions) for handling various basic system services for performing hardware dependent tasks. While not explicitly indicated in the computer system 200, in some embodiments the operating system 226 includes a web browser. The memory 224 may also store procedures (or a set of instructions) in a communication module 228. The communication procedures may be used for communicating with one or more computers and/or servers, including computers and/or servers that are remotely located with respect to the computer system 200.

Memory 224 may also include multiple program modules (or a set of instructions), including financial planning module 230 (or a set of instructions) and financial-aid module 232 (or a set of instructions). As noted previously, in some embodiments, the financial-aid module 232 is embedded in the financial-planning module 230 and is configurable or configured to execute in the environment of the financial-planning module 230.

Furthermore, memory 224 may include one or more electronic templates 234 that are compatible with formats of corresponding financial-aid applications. In addition, memory 224 may optionally include financial information 236 and/or additional information 244 for one or more individuals. (As noted previously, in some embodiments at least some of the financial information 236 and/or the additional information 244 is stored remotely from the computer system 200.) The optional financial information 236 may optionally include bank records 238, investment records 240, and/or income tax returns 242. Furthermore, in some embodiments memory 224 includes at least one partially complete electronic template 246.

Memory 224 may include one or more security tokens 248 to restrict access to stored data such as the financial information 236. Security may also be enhanced using an encryption module 250 (or a set of instructions) that encrypt data and/or stored information. And in some embodiments, an eligibility prediction module 252 (or a set of instructions) assists users of the financial-aid module 232 in determining the consequences of the information they are provided in one or more of the electronic templates 234 prior to its submission to an organization, such as the financial-aid evaluator 116 (FIG. 1).

Instructions in the various modules in the memory 224 may be implemented in a high-level procedural language, an object-oriented programming language, and/or in an assembly or machine language. The programming language may be compiled or interpreted, i.e, configurable or configured to be executed by the one or more processing units 210.

Although the computer system 200 is illustrated as having a number of discrete items, FIG. 2 is intended to be a functional description of the various features that may be present in the computer system 200 rather than as a structural schematic of the embodiments described herein. In practice, and as recognized by those of ordinary skill in the art, the functions of the computer system 200 may be distributed over a large number of servers or computers, with various groups of the servers or computers performing particular subsets of the functions. In some embodiments, some or all of the functionality of the computer system 200 may be implemented in one or more ASICs and/or one or more digital signal processors DSPs.

The computer system 200 may include fewer components or additional components, two or more components may be combined into a single component, and/or a position of one or more components may be changed. In some embodiments the functionality of the computer system 200 may be implemented more in hardware and less in software, or less in hardware and more in software, as is known in the art.

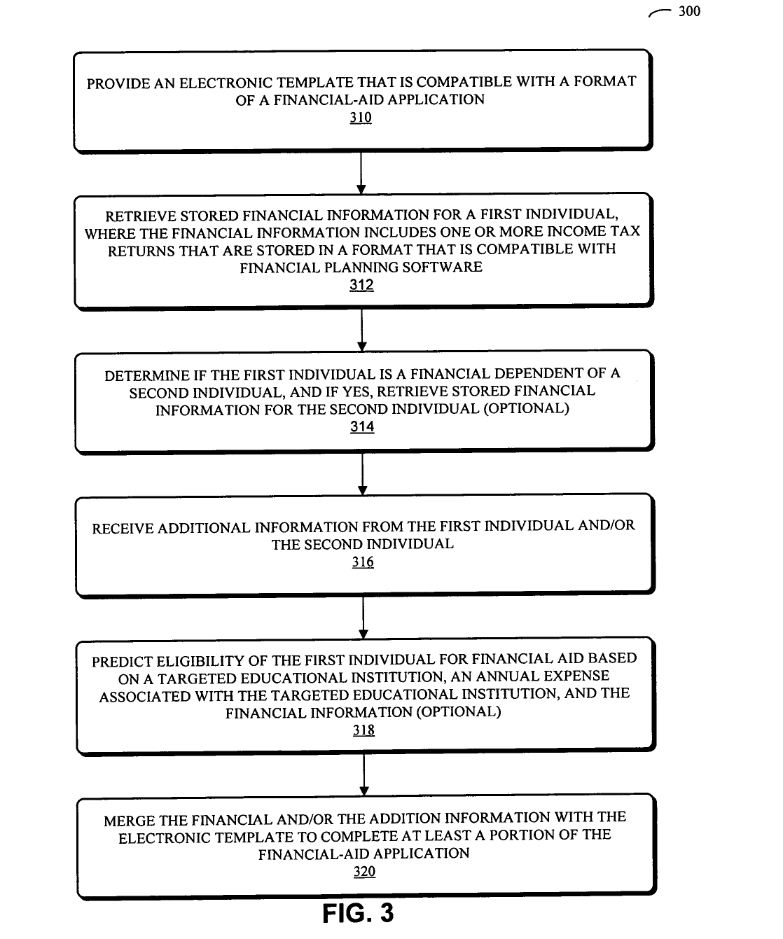

We now discuss methods for generating a financial-aid application. FIG. 3 provides a flow chart illustrating a process 300 for generating a financial-aid application in accordance with an embodiment of the present invention. During this process, the system provides an electronic template that is compatible with a format of a financial-aid application (310) and the system retrieves stored financial information for a first individual (312). Note that this financial information may include one or more income tax returns that are stored in a format that is compatible with financial planning software. Furthermore, the system determines whether or not the fist individual is a financial dependent on a second individual, and if the first individual is a financial dependent, the system may optionally retrieve stored financial information for the second individual (314).

Then, the system receives additional information from the first individual and/or the second individual (316) and the system may optionally predict eligibility of the first individual for financial aid (318). This prediction may be based on a targeted educational institution, an annual expense associated with the targeted educational institution, and the financial information for either the first individual and/or the second individual. In addition, the system merges financial and/or the addition information for the first individual and/or the second individual with the electronic template to complete at least a portion of the financial-aid application (320). Note that in some embodiments there may be additional or fewer operations, the order of the operations may be changed, and two or more operations may be combined into a single operation.

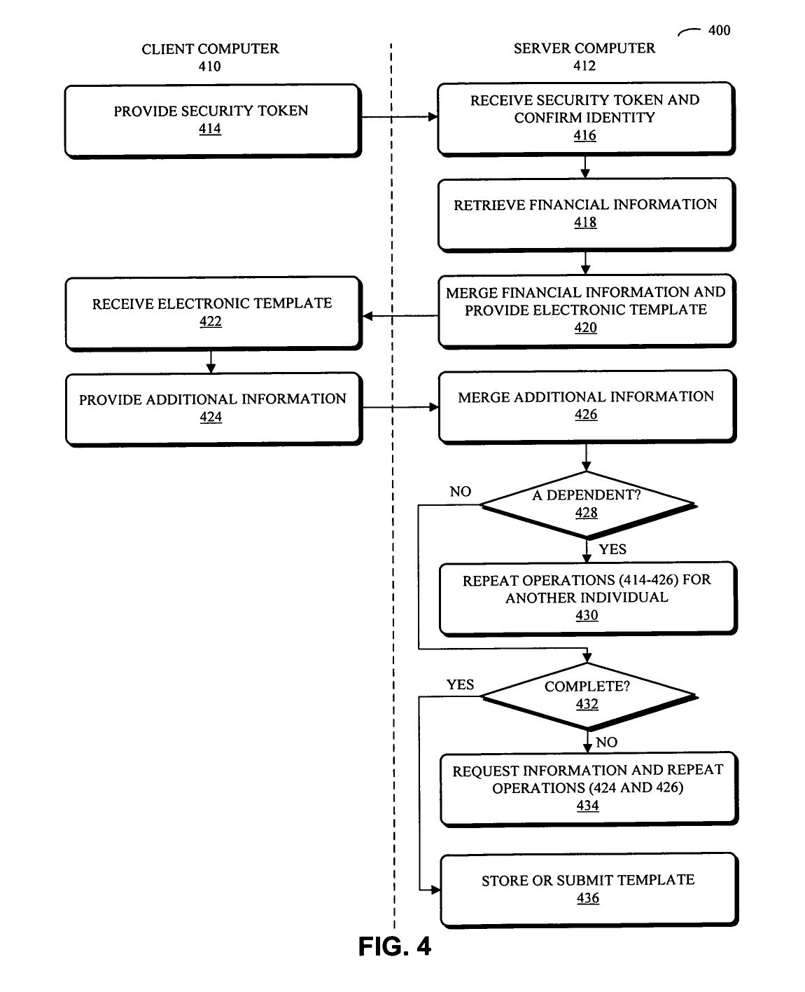

FIG. 4 is a flow chart illustrating a process 400, such as that utilized in an on-line environment, for generating a financial-aid application in accordance with an embodiment of the present invention. During the process 400, a user of the financial-aid program or tool at a client computer 410 provides a security token (414) that is transmitted via a network, such as the network 112 (FIG. 1), to a sever computer 412. The system receives this security token and confirms an identity of the user (416).

Then, the system retrieves financial information for the user (418). The system merges this financial information with an electronic template that is compatible with a financial-aid application and provides the electronic template to the user (420). Here, the user receives the electronic template (422) and provides additional information (424). In some embodiments, the system queries the user to provide the additional information. The system then merges the additional information with the electronic template (426).

Furthermore, the system makes a determination as to whether or not the user is financially dependent on another individual(s) (428). If the user is financially dependent, operations 414-426 are repeated to obtain financial and/or additional information for another individual (430).

After completing these operations or if the user is not financially dependent, the system determines whether or not the electronic template is complete (432). If the electronic template is not complete, the system requests additional information and operations 424 and 426 repeat (434).

Once the system completes these operations or if the electronic template is already complete, the system either stores or submits the electronic template (436). Note that in some embodiments there may be additional or fewer operations, the order of the operations may be changed, and two or more operations may be combined into a single operation.

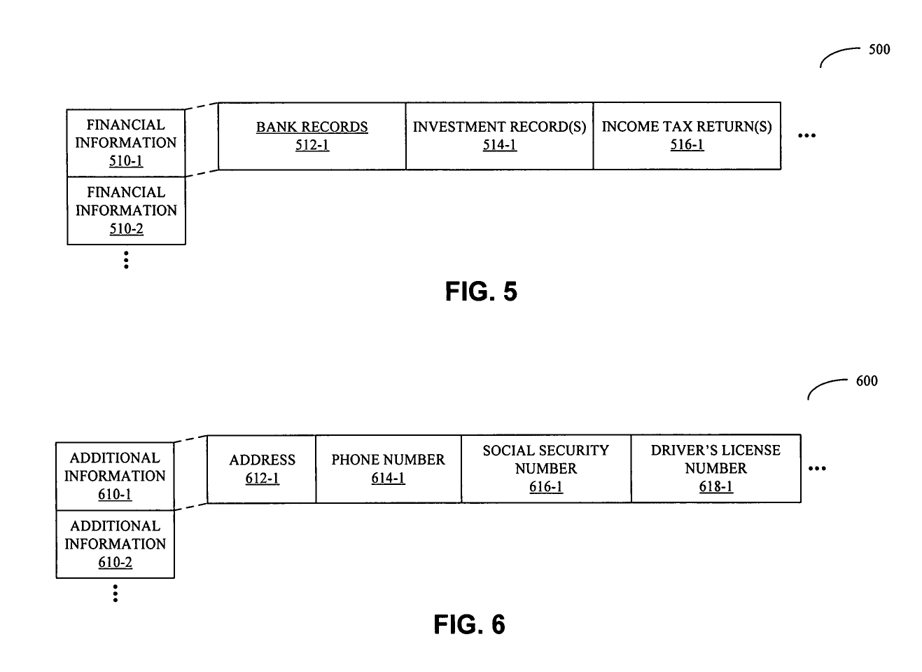

We now discuss data structures that may be used in the computer system 100 (FIG. 1) and/or 200 (FIG. 2). FIG. 5 provides a block diagram illustrating a data structure 500 in accordance with an embodiment of the present invention. This data structure may include financial information 510 for one or more users of the financial-aid program. The financial information 510 may include bank records 512, investment records 514, and/or income tax returns 516.

FIG. 6 provides a block diagram illustrating a data structure 600 in accordance with an embodiment of the present invention. This data structure may include additional information 610 for one or more users of the financial-aid program. The additional information 610 may include an address 612, a phone number 614, a social security number 616, and/or a driver's license number 618. Note that that in some embodiments of the data structures 500 and/or 600 there may be fewer or additional components, two or more components may be combined into a single component, and/or a position of one or more components is changed.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for generating a financial-aid application, comprising:
providing an electronic template, wherein the electronic template is compatible with a format of the financial-aid application;
retrieving stored financial information for a first individual, wherein the financial information includes one or more income tax returns, and wherein the one or more income tax returns are stored in a format that is compatible with financial planning software; and
merging the financial information with the electronic template to complete at least a portion of the financial-aid application.

2. The method of claim 1, wherein the financial information further includes bank statements or investment records.

3. The method of claim 1, wherein the financial planning software includes Quicken™ or TurboTax™.

4. The method of claim 1, further comprising:
receiving additional information corresponding to the first individual; and
merging the additional information with the electronic template.

5. The method of claim 4, wherein the additional information includes an address, a phone number, a Social Security number, or a driver's license number.

6. The method of claim 1, wherein the financial-aid application includes a Free Application for Federal Student Aid (FAFSA).

7. The method of claim 1, wherein the financial information is stored at a remote location and is accessed via a network.

8. The method of claim 1, further comprising verifying accuracy of information that is merged with the electronic template.

9. The method of claim 1, further comprising determining that additional information is required to complete the financial-aid application.

10. The method of claim 9, further comprising providing a list of the additional information.

11. The method of claim 9, further comprising querying a user for at least a portion of the additional information.

12. The method of claim 9, further comprising sending a request to a third party for at least a portion of the addition information.

13. The method of claim 1, further comprising storing a partially completed electronic template.

14. The method of claim 1, further comprising retrieving a partially completed electronic template.

15. The method of claim 1, further comprising receiving a security token corresponding to the first individual.

16. The method of claim 1, further comprising:
determining if the first individual is a financial dependent of a second individual; and
if so, retrieving stored financial information for the second individual and merging this financial information with the electronic template to complete at least a portion of the financial-aid application.

17. The method of claim 1, further comprising predicting eligibility of the first individual for financial aid based on:
a targeted educational institution;
an annual expense associated with the targeted educational institution; and
the financial information.

18. The method of claim 1, further comprising electronically submitting the electronic template to an organization that determines eligibility of the first individual for financial aid.

19. A computer program product for use in conjunction with a computer system, the computer program product comprising a computer-readable storage medium and a computer-program mechanism embedded therein for configuring the computer system, the computer-program mechanism including:
instructions for providing an electronic template, wherein the electronic template is compatible with a format of a financial-aid application;
instructions for retrieving stored financial information corresponding to a first individual, wherein the financial information includes one or more income tax returns, and wherein the one or more income tax returns are stored in a format that is compatible with financial planning software; and
instructions for merging the financial information with the electronic template to complete at least a portion of the financial-aid application.

20. A computer system, comprising:
a processor;
memory;
a program module, wherein the program module is stored in the memory and configurable to be executed by the processor, the program module including:
instructions for providing an electronic template, wherein the electronic template is compatible with a format of a financial-aid application;
instructions for retrieving stored financial information corresponding to a first individual, wherein the financial information includes one or more income tax returns, and wherein the one or more income tax returns are stored in a format that is compatible with financial planning software; and
instructions for merging the financial information with the electronic template to complete at least a portion of the financial-aid application.
